(19) United States
(12) Patent Application Publication
(10) Pub. No.: US 2025/0107523 A1
(43) Pub. Date: Apr. 3, 2025

(54) TRIGGERING DIATOM PROGRAMMED CELL DEATH BY STIMULATING INFOCHEMICAL SIGNALING SYSTEMS

(71) Applicant: BATTELLE MEMORIAL INSTITUTE, Columbus, OH (US)

(72) Inventors: Robert W. MURDOCH, Columbus, OH (US); Victoria E. SIMONS, Columbus, OH (US); Ashley M. FRANK, Columbus, OH (US); Llanicelis Mojica VELAZQUEZ, Columbus, OH (US); Angel Rubio MARRERO, Columbus, OH (US); Jerry S. Casbohm, Columbus, OH (US); Sarah Ducceschi, Columbus, OH (US); Savannah Pace, Columbus, OH (US)

(21) Appl. No.: 18/899,680

(22) Filed: Sep. 27, 2024

Related U.S. Application Data
(60) Provisional application No. 63/586,210, filed on Sep. 28, 2023.

(51) Int. Cl. A01N 31/02; A01N 31/04; A01N 33/20; A01P 1/00

(52) U.S. Cl. CPC A01N 31/02; A01N 31/04; A01N 33/20; A01P 1/00

(57) ABSTRACT

Compositions and methods are provided for controlling the growth and spread of unicellular algae.

### CROSS-REFERENCE TO RELATED APPLICATIONS

This application claims priority under 35 U.S.C. § 119(e) to U.S. Provisional Application Ser. No. 63/586,210 filed on Sep. 28, 2023, the disclosure of which is expressly incorporated herein.

### BACKGROUND

Many types of algae, including cyanobacteria, dinoflagellates and diatoms, can generate massive populations with densities greater than 15,000,000 cells per liter, stretching for hundreds or even thousands of square kilometers in water bodies. These blooms can proliferate and dieback in a matter of days or return seasonally for decades. Some algal blooms pose no threat to other life forms, and simply provide an abundant food source for various predators. However, in other instances impacts may be catastrophic. Harmful algal blooms have cost lives and resources and continue to worsen with global climate change, which tends to select for noxious and toxic algae, as many of these organisms are favored by warmer waters.

Diatom blooms are dynamic system events during which certain photosynthetic single-celled organisms can exploit both biotic and abiotic factors to become dominant. Blooms can involve more than one type of microbe and often result from and influence interactions between predators and prey. Diatoms (Bacillariophyta) are part of the algal community sometimes referred to as “hard algae” because of their silica frustule that is often ornamented with elaborate spikes, thorns, or spines. While these structural adaptations are known to confer advantage by facilitating suspension in the water column, they also can serve as effective predatory defenses. Some diatoms can form long filamentous ribbons or chains and may also have spines or sharp projections. When these species bloom, their anatomical enhancements cause serious or fatal injury to predators as can happen with many Chaetoceros species clogging or puncturing fish gills with their needle-like setae.

There are no approved diatom-specific pesticides. The algaecide/herbicide Hydrothol has an LC50 in the mg/L range, but is highly toxic to all algae, plants, and fish. An evaluation of available control chemicals against the freshwater invasive diatom Didymosphenia geminata (Arch Environ Contam Toxicol (2011) 61:115-127) determined that no treatment was both effective and specific.

Insecticides tend to target insect nervous systems, and herbicides often target plant growth signaling systems (auxin). In both cases, the most effective way to kill is to find the most sensitive trigger; chemical receptors that when stimulated lead to widespread effects. The discovery of such a parallel system in diatoms offers an equally-effective path, which instead of attempting to attack structures or cripple metabolisms, triggers a programmed-cell-death (apoptosis) cascade believed to be utilized by diatoms to control population sizes. While there exists some limited knowledge on how marine diatoms use chemical signals (“infochemicals”) to trigger cell death in their own populations, synergistic effectiveness of known signals has not been examined. It has been demonstrated, based on limited genome analyses, that other groups of algae do not have the same signaling systems as diatoms, suggesting that this unique programmed-cell-death system may be effective for specific control of diatoms.

For example, two chemicals, trans,trans-2,4-decadienal (TDD) and cholesterol-3-sulfate (C3S), have been demonstrated to lead to programmed-cell-death in model diatoms at micromolar levels. There is also evidence that these chemical signals exploit pathways that are not utilized by other algae, and thus are potentially much less harmful to other organisms in a community. These chemicals both lead to cell death at micromolar levels, slightly less effective than the broad-spectrum algicide/herbicide Hydrothol but much more targeted. The effectiveness of a combination of TDD and C3S, or the combination of either infochemical with broad-spectrum algicides, has not been examined empirically. TDD/C3S offer an entirely novel class of diatom control agents, which may be applied as an aquatic algicide in formulation with stabilizers, emulsifiers, solubilizing agents and the like, or may be used as anti-biofouling surface additives in aquatic materials.

### SUMMARY

The present disclosure is directed to compositions and methods for controlling the growth of algal species. More particularly, in one embodiment isolated infochemicals native to diatoms are used to induce programmed-cell-death in specific targeted algae, including single cell algae species such as Didymosphenia geminata, while minimizing detrimental effects on fish and non-target aquatic life. In one embodiment a method for inhibiting the growth of a unicellular algae species in a body of water is provided. In one embodiment the method involves killing the targeted unicellular algae species. In one embodiment the method comprising contacting the algae species with a composition comprising an effective amount of a first infochemical that induces programmed-cell-death, wherein the infochemical is native to the programmed-cell-death system of a unicellular algae species. The method can also include the administration of two or more infochemicals and/or the administration of a low dose of commercially available algicides, wherein the commercial algicide is applied at concentrations at or less than 25%, 20%, 15%, 10% or 5% of the recommended dosage.

In one embodiment a method for inhibiting the growth of a unicellular algae species in a body of water is provided wherein the algae species is contacted with a composition comprising an isolated polyunsaturated aldehyde infochemical, and a known algicide compound, including for example, an algicide selected from the group consisting of copper sulfate, poly(oxyethylene) (dimethylimino) ethylene (dimethylimino) ethylene dichloride, sodium percarbonate, endothall dipotassium or monoamine salt, sodium carbonate peroxyhydrate and copper ethanolamine complex In one embodiment the algicide is provided as a commercial algicide selected from the group consisting of AlgaeFix™, DINO X, Aquathol® K, GreenClean® PRO and Cutrine® Plus, administered at doses below the manufacturer's suggested concentrations, including for example at or less than 15%, 10% or 5% recommended concentrations. In accordance with one embodiment the algicides are administered (in conjunction with an unsaturated aldehyde infochemical) at a concentrations of about 0.2 to about 0.3 mg/L of copper sulfate, about 0.1 to about 0.15 mg/L of poly(oxyethylene) (dimethylimino) ethylene (dimethylimino) ethylene dichloride, about 0.4-5 mg/L salts of endothall, about 2.5 to about 3.5 mg/L of sodium carbonate peroxyhydrate, and about 0.2 to about 0.3 mg/L copper ethanolamine complex. In one embodiment the algicides are administered (in conjunction with an unsaturated aldehyde infochemical) at a concentrations of about 0.26 mg/L of copper sulfate, about 0.12 mg/L of poly(oxyethylene) (dimethylimino) ethylene (dimethylimino) ethylene dichloride, about 0.4-5 mg/L salts of endothall, about 3.1 mg/L of sodium carbonate peroxyhydrate, and about 0.26 mg/L copper ethanolamine complex. In one embodiment the polyunsaturated aldehyde infochemical is decadienal or decatrienal, optionally administered at a concentration of about 5 to about 20 micromolar, or about 10 micromolar.

The present disclosure also encompasses compositions for inhibiting the growth or eliminating a single celled algal infestation. In one embodiment the composition comprises a combination of two or more infochemicals, wherein said infochemicals induce programmed-cell-death in diatoms, and wherein the infochemicals are native to the programmed-cell-death system of a unicellular algae species. Such compositions can be further supplemented with very low concentrations of commercial algicides to produce a synergistic killing effect. In one embodiment, a programmed-cell-death triggering composition is provided wherein the composition comprises an isolated polyunsaturated aldehyde infochemical and a commercial algicide selected from the group consisting of AlgaeFix™, DINO X, Aquathol® K, GreenClean® PRO and Cutrine® Plus. The compositions can be formulated as a liquid, or in the form of solid granules that release the active components over time upon contact with an aqueous medium. In one embodiment the polyunsaturated aldehyde infochemical is trans,trans-2,4-decadienal or decatrienol, and optionally the infochemical is trans,trans-2,4-decadienal.

### BRIEF DESCRIPTION OF DRAWINGS

FIG. 1. Lethality of 10 micromolar infochemical trans,trans-2,4-decadienal (TDD) alone and in combination with commercial algicides at the manufacturer's recommended dose (MRD); algae_only=Negative control; TDD_only: Infochemical only, no algicide; AF: AlgaeFix™, AQ: Aquathol® K, Cu: Cutrine® Plus, DX: DINO X, GCP: GreenClean® PRO, Hy: Hydrothol® 191

FIG. 2 presents a plot showing the effects of dienal infochemicals (including TDD, and novel chemicals based on TDD) on the freshwater diatom alga Gomphonema affine, with and without the addition of the commercial algicide AlgaeFix. Lane 1 represents diatoms treated with a dose of AlgaeFix at 0.1× the manufacturer's recommended dose (MRD); Lanes 2-9 represent diatoms treated with (E,E)-5-Phenyl-2,4-pentadienal (D1), Methyl (2E,4E)-6-oxo-2,4-hexadienoate (D10); (2E,4E)-5-(4-Nitrophenyl)-2,4-pentadienal (D2); (2E,4E)-5-(3-Furanyl)-2,4-pentadienal (D4); (2E,4E)-5-(4-Bromophenyl)-2,4-pentadienal (D5); 5-[4-(Acetyloxy)-3-methoxyphenyl]-2,4-pentadienal (D7), (E,E)-5-(9-anthracenyl)-2,4-penta-2,4-dienal (D8) and trans,trans-2,4-decadienal (TDD), respectively, at a dosage of 10 μM for each dienal alone, or in combination with either a 0.1×MRD dosage of AlgaeFix or a 1×MRD dosage of AlgaeFix. Lanes 10 and 11 represent diatoms treated with either a 1×MRD dose of AlgaeFix (1×) or a 10×MRD dose of AlgaeFix (10×). Lanes 12 and 13 are controls where the diatoms are contacted with a dose of 4 μL DMSO (the carrier for the dienals) or 20 μL water (the carrier for the commercial algicide), respectively.

This data shows that dosing with AlgaeFix at the MRD only kills about 50% of the diatoms. By adding in 10 μM of certain dienal infochemicals, the mortality increases to around 85%—similar to a 10× dose of algicide alone. This demonstrates that by adding in certain dienals, the effectiveness of an algicide against diatoms can be increased.

### DETAILED DESCRIPTION

### Definitions

The term “about” as used herein means greater or lesser than the value or range of values stated by 10 percent but is not intended to limit any value or range of values to only this broader definition. Each value or range of values preceded by the term “about” is also intended to encompass the embodiment of the stated absolute value or range of values.

As used herein, the term “purified” and like terms relate to the isolation of a molecule or compound in a form that is substantially free of contaminants normally associated with the molecule or compound in a native or natural environment. As used herein, the term “purified” does not require absolute purity; rather, it is intended as a relative definition.

The term “isolated” requires that the referenced material be removed from its original environment (e.g., the natural environment if it is naturally occurring). For example, a naturally-occurring compound present in a living animal is not isolated, but the same compound, separated from some or all of the coexisting materials in the natural system, is isolated.

As used herein the term “infochemical” is any molecule that functions as a signal to activate cell responses in relation to environmental pressures and constraints, such as a lack of nutrients, or overcrowding.

As used herein the term “algal bloom” defines a condition of excessive or dense growths of a single or several species of algae.

As used herein the term “algicide” defines a chemical compound that kills algae. A commercial algicide is an algicide that is commercially available and sold for the purpose of controlling algae populations.

As used herein the term “formulation” defines a composition which comprises the active ingredient, inert ingredients and may contain a carrier, and/or other additives.

As used herein the term “granular herbicide” or “pellet formulation” defines a dry herbicide formulation that is formed into small particles (granules), most of which may be composed of inert material. The granules aid in the even distribution of the herbicide and possible extended timed release of the active agent.

As used herein the term “wettable powder” defines a finely divided dry formulation that can be readily suspended in water.

### EMBODIMENTS

The present disclosure is directed to the use of isolated infochemicals and derivatives thereof for controlling the population size of single cell algae, including for example Didymosphenia geminata. Cell mortality is a key mechanism that shapes phytoplankton blooms and species dynamics in aquatic environments. Diatoms are known to express various infochemicals, including sterol sulfates and unsaturated aldehydes, that can induce apoptosis-like cell death. Compositions comprising these isolated infochemicals, and/or derivative species thereof, can be used as an exogenous source of these cell signaling moieties to narrowly target and regulate algal growth and/or eliminate algal infestations and blooms with minimal impact on fish and other non-targeted aquatic life.

Advantageously, applicant has found that certain combinations of infochemicals and standard algicides can produce a synergistic lethality on single cell algae. For use together, it is not necessary that the infochemical and second active agent be applied in a physically combined form, or even at the same time. The combination effect results so long as the two or more active agents are present in contact with the target species at the same time, regardless of when they were applied. Thus, for instance a physical combination of the two or more active agents could be applied, or one or some could be applied earlier than the other(s). In one embodiment compositions comprising infochemicals that induce programmed cell death are used in conjunction with low levels of a commercial algicide to produce a synergistic effect and enhance the ability of infochemicals to kill single cell algae and reduce population sizes of algal blooms. In one embodiment, only a very small amount of the commercial algicide (e.g., less than 10% of the recommended dosage) is required when used in conjunction with the infochemicals disclosed herein to achieve a synergistic lethality to single cell algae. As used herein, “in conjunction with” is intended to encompass simultaneous contact of single cell algae with the two compounds, or a sequential contact with the two compounds where the interval between the sequential contact can be 5, 30, 60, 120, 480 minutes or 12 or 24 hours.

The active agents of the presently disclosed compositions and methods can be applied separately in liquid or solid form, or as a combination product containing some or all the active agents, again in either liquid or solid form. Typical liquid formulations include emulsions, suspensions (including suspensions containing microcapsules), solutions, emulsifiable concentrates, and flowables. Common solid forms include granules, wettable powders, water-dispersible solid (including water-dispersible granules containing microencapsulated pesticides) or dusts. The formulations can also contain, in addition to the active agents' other ingredients such as solvents, wetting agents, suspending agents, anti-caking agents, dispersing agents, emulsifiers, antifreeze agents, antifoam agents, and other additives.

Compositions according to this disclosure may contain two or more active agents in numerous different physical forms. In some cases, a composition may be produced by simply physically mixing (“tank mixing”) two separate compositions, wherein the compositions comprise two different active agents in accordance with the present disclosure. Alternatively, a package may be manufactured and sold which contains the two or more active agents in separate containers, but packaged together, e.g. in a “multi-pack” format such as a “twin-pack” or “tri-pack”. In one embodiment the two active agents comprise a diatom infochemical, (optionally a polyunsaturated aldehyde) and a commercial herbicide (optionally selected from the group consisting of AlgaeFix™, DINO X, Aquathol® K, GreenClean® PRO and Cutrine® Plus). In use, the combination of active agents utilized should remain at herbicidal effective levels in the body of water and/or in contact with the targeted species for sufficient time to achieve control.

In accordance with one embodiment the infochemical used in accordance with the present disclosure is a sterol sulfate having the general structure of:

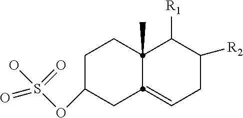

wherein R₁ and R₂ together with the atoms to which they are bound form a sterol. In one embodiment the sterol sulfate is cholesterol-3-sulfate (C3S).

In one embodiment the infochemical used in accordance with the present disclosure is an unsaturated aldehyde comprising 8-12 carbon atoms, optionally wherein the infochemical is a polyunsaturated aldehyde comprising 8-12 carbon atoms. In one embodiment the unsaturated aldehyde has the general structure of:

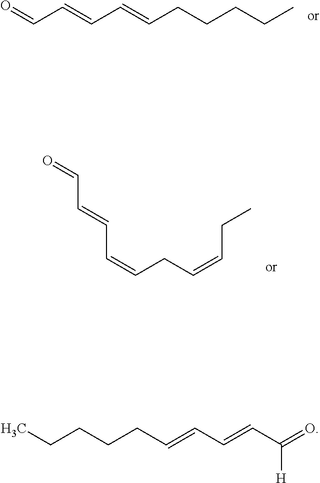

In one embodiment the polyunsaturated aldehyde is selected from the group consisting of trans,trans-2,4-decadienal, 2-trans, 4-cis, 7-cis-decatrienal; and 2-trans, 4-trans, 7-cis-decatrienal. Trans,trans-2,4-decadienal has been found to be an effective diatomicide at concentrations of about 50 to about 100 μM, a similar level of efficacy as commercial algicides. Lower concentrations of trans,trans-2,4-decadienal are effective when trans,trans-2,4-decadienal is combined with administration of commercial algicides, leading to a synergistic lethality that is more than the sum of the parts.

In one embodiment the polyunsaturated aldehyde is a dienal selected from the group consisting of
trans,trans-2,4-decadienal
(E,E)-5-Phenyl-2,4-pentadienal;
(2E,4E)-5-(4-Nitrophenyl)-2,4-pentadienal;
(2E,4E)-5-[4-(Dimethylamino)phenyl]-2,4-pentadienal;
(2E,4E)-5-(3-Furanyl)-2,4-pentadienal;
(2E,4E)-5-(4-Bromophenyl)-2,4-pentadienal;
5-(4-Methoxyphenyl)penta-2,4-dienal;
5-[4-(Acetyloxy)-3-methoxyphenyl]-2,4-pentadienal;
(E,E)-5-(9-anthracenyl)-2,4-penta-2,4-dienal;
(E,E)-2,4-Heptadienal;
Methyl (2E,4E)-6-oxo-2,4-hexadienoate; and
3-[3-(4-Fluorophenyl)-2,3-dihydro-1-(1-methylethyl)-1H-indol-2-yl]-2,4-pentadienal. In one embodiment the polyunsaturated aldehyde is a dienal having the general structure of

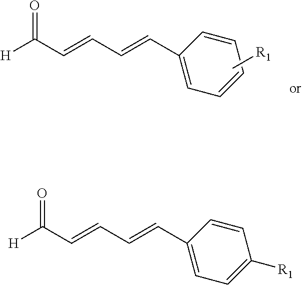

wherein R₁ is selected from the group consisting of H, halo, NH₂, NO₂ and OCH₃. In one embodiment the polyunsaturated aldehyde is a dienal selected from the group consisting of
trans,trans-2,4-decadienal
(E,E)-5-Phenyl-2,4-pentadienal; and
(2E,4E)-5-(4-Nitrophenyl)-2,4-pentadienal.

In one embodiment a sterol sulfate and an unsaturated aldehyde are used in conjunction to treat a body of water to eliminate undesirable single cell algae from the body of water. In one embodiment the body of water is treated with cholesterol-3-sulfate and trans,trans-2,4-decadienal, optionally wherein the compounds are administered simultaneously, optionally as a single formulation. In a further embodiment the method may further be conducted in conjunction with the application of a low dose (equal to or less than the recommended dosage) of a commercial algicide, optionally selected from the group consisting of AlgaeFix™, DINO X, Aquathol® K, GreenClean® PRO and Cutrine® Plus.

In accordance with one embodiment a method is provided for controlling, reducing, or eliminating single celled algae from an aqueous environment while minimizing detrimental effects on non-targeted aquatic life. Bodies of water to be treated with the present methods will typically be fresh water bodies such as ponds, lakes, wet lands, reservoirs, rivers or irrigation canals, although other bodies of water may also be treated in accordance with the present disclosure. The method of treatment comprises contacting the algae with a composition comprising an infochemical, wherein the infochemical is a compound native to diatoms and is associated with programmed cell death. In one embodiment the algae is contacted with the infochemical in conjunction with the administration of a second active agent. The second active agent can be a second infochemical that is different from the first infochemical, or the second active agent can be a commercially available algicide. When a commercially available algicide is used in conjunction with an infochemical, the commercially available algicide can optionally be used at very low levels, including for example, at concentrations at or less than 50%, 25%, 20%, 15%, 10% or 5% of the recommended dosage.

In one embodiment a method is provided for controlling, reducing, or eliminating single celled algae from an aqueous environment while minimizing detrimental effects on non-targeted aquatic life, wherein the method comprises contacting algae with one or more dienals selected from the group consisting of trans,trans-2,4-decadienal
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate, and
3-[3-(4-Fluorophenyl)-2,3-dihydro-1-(1-methylethyl)-1H-indol-2-yl]-2,4-pentadienal in conjunction with a commercially available algicide at the recommended dosage or at a dosage less than the manufacturer's recommended dosage. In one embodiment one or more dienals selected from the group consisting of (E,E)-5-Phenyl-2,4-pentadienal, (2E,4E)-5-(4-Nitrophenyl)-2,4-pentadienal and (2E,4E)-5-[4-(Dimethylamino)phenyl]-2,4-pentadienal are placed in contact with algae in conjunction with a commercial algicide, optionally wherein the algicide is selected from the group consisting of AlgaeFix™, DINO X, Aquathol® K, GreenClean® PRO and Cutrine® Plus. In one embodiment a composition is provided comprising dienals selected from the group consisting of trans,trans-2,4-decadienal
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate, and
3-[3-(4-Fluorophenyl)-2,3-dihydro-1-(1-methylethyl)-1H-indol-2-yl]-2,4-pentadienal and a commercially available algicide.

In accordance with one embodiment the infochemical and a second active agent are applied simultaneously, and optionally as a single composition. The algae inhibiting composition can be prepared as a mixture of the two active components as a liquid or as a dried powder. The algae can be contacted with the compositions using techniques known to those skilled in the art, including distribution of a dried powder or liquid form onto the surface of the aqueous environment to be treated. In accordance with one embodiment the compositions comprising the infochemical and a second active agent are formulated as a time release composition, wherein the active agents are released over an extended period. In one embodiment the composition is formulated as a solid pellet of inert material that slowly dissolves upon contact with an aqueous media and releases the active agent as the pellet dissolves.

In accordance with one embodiment a method for inhibiting the growth of a unicellular algae species such as Didymosphenia geminata in a body of water is provided, wherein the method comprising contacting the algae species with an isolated polyunsaturated aldehyde infochemical, in conjunction with contacting the algal species with a commercial algicide selected from the group consisting of AlgaeFix™, DINO X, Aquathol® K, GreenClean® PRO and Cutrine® Plus. In accordance with one embodiment the isolated polyunsaturated aldehyde infochemical and the commercial algicide are applied simultaneously, and in one embodiment the isolated polyunsaturated aldehyde infochemical and the commercial algicide are mixed together and applied as a single composition. In embodiments using commercial algicides, the final concentration of the applied commercial algicide is at or less than the manufacturer's recommended dose including less than 15%, 10% or 5% of the recommended dosage. In one embodiment the final concentration of the applied commercial algicide is 10% of the recommended dosage (i.e., 0.1×). In one embodiment the commercial algicide is selected from AlgaeFix™, DINO X, Aquathol® K, GreenClean® PRO and Cutrine® Plus applied at a final dosage of less than 15%, 10% or 5% of the recommended dosage. In one embodiment the commercial algicide is selected from AlgaeFix™, DINO X, and Aquathol® K applied at a final dosage of less than 15%, 10% or 5% of the recommended dosage. In one embodiment the commercial algicide is selected from AlgaeFix™ and DINO X, applied at a final dosage of less than 15%, 10% or 5% of the recommended dosage.

In accordance with one embodiment the polyunsaturated aldehyde infochemical used in conjunction with the commercial algicide is trans,trans-2,4-decadienal or decatrienal. In one embodiment a method of increasing cell death in unicellular algae in a body of water is provided wherein trans,trans-2,4-decadienal or decatrienal is applied in conjunction with a commercial algicide selected from the group consisting of AlgaeFix™, DINO X, Aquathol® K, GreenClean® PRO and Cutrine® Plus, wherein the commercial algicide is applied at a final dosage of less than 15%, 10% or 5% of the recommended dosage.

In one embodiment a composition for inhibiting the growth of a unicellular algae species is provided wherein the composition comprises an isolated polyunsaturated aldehyde infochemical, wherein the polyunsaturated aldehyde is native to a diatom species; and a commercial algicide selected from the group consisting of a low dosage of AlgaeFix™, DINO X, Aquathol® K, GreenClean® PRO and Cutrine® Plus. The composition can be formulated with acceptable carriers and excipients as either a liquid, wettable powder, or granules.

### EXEMPLARY EMBODIMENTS

In accordance with embodiment 1, a method for inhibiting the growth of a unicellular algae species, eliminating a unicellular algae species from a body of water or enhancing the death of a unicellular algae species in a body of water, while minimizing any harmful impact to non-targeted aquatic life such as fish, is provided, wherein the method comprises contacting the algae species with a composition comprising an effective amount of a first active agent, wherein the first active agent is an exogenous source of a first infochemical that induces programmed-cell-death, wherein the infochemical is native to the programmed-cell death system of a unicellular algae species, optionally wherein the first active agent is a polyunsaturated aldehyde, including for example a dienal such as trans,trans-2,4-decadienal.

In accordance with embodiment 2, the method of embodiment 1 is provided further comprising the step of contacting the algae species with a second active agent.

In accordance with embodiment 3, the method of embodiment 2 is provided wherein the second active agent is a second infochemical that is distinct from the first infochemical, optionally wherein the first infochemical is a polyunsaturated aldehyde, optionally trans,trans-2,4-decadienal, and the second active agent is a sterol sulfate having the general structure of:

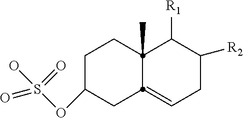

wherein R₁ and R₂ together with the atoms to which they are bound form a sterol, optionally wherein the sterol sulfate is cholesterol-3-sulfate (C3S).

In accordance with embodiment 4, the method of embodiment 2 is provided wherein the second active agent is a commercially available algicide, wherein the commercial algicide is applied at or less than the manufacturer's recommended dosage, optionally wherein the commercial algicide has an active agent selected from the group consisting of copper sulfate, poly(oxyethylene) (dimethylimino) ethylene (dimethylimino) ethylene dichloride, sodium percarbonate, endothall, sodium carbonate peroxyhydrate and copper ethanolamine complex, optionally wherein the commercial algicide is applied at 100%, less than 100%, less than 50% or less than 10% of the manufacturer's recommended dose, optionally wherein the commercial algicide is selected from Cutrine® Plus, GreenClean® PRO, Hy: Hydrothol® 191, AlgaeFix™, DINO X, and Aquathol® K.

In accordance with embodiment 5β method for inhibiting the growth of a unicellular algae, eliminating a unicellular algae species from a body of water or enhancing the death of a unicellular algae species in a body of water is provided wherein the unicellular algae species is contacted with a polyunsaturated aldehyde, optionally wherein the polyunsaturated aldehyde is a dienal selected from the group consisting of
trans,trans-2,4-decadienal,
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate and
3-[3-(4-Fluorophenyl)-2,3-dihydro-1-(1-methylethyl)-1H-indol-2-yl]-2,4-pentadienal.

In accordance with embodiment 6, the method of embodiment 5 is provided wherein the polyunsaturated aldehyde is a dienal having the general structure of

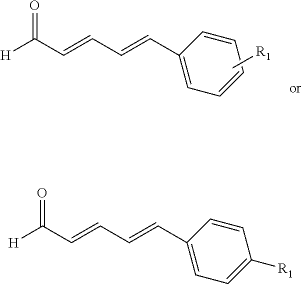

wherein R₁ is selected from the group consisting of H, halo, NH₂, NO₂ and OCH₃.

In accordance with embodiment 7 the method of embodiment 5 is provided wherein the polyunsaturated aldehyde is a dienal selected from the group consisting of
trans,trans-2,4-decadienal,
(E,E)-5-Phenyl-2,4-pentadienal and
(2E,4E)-5-(4-Nitrophenyl)-2,4-pentadienal.

In accordance with embodiment 8, the method of embodiment 7 is provided wherein the unicellular algae is contacted with a composition comprising:
i) trans,trans-2,4-decadienal;
ii) (E,E)-5-Phenyl-2,4-pentadienal;
iii) (2E,4E)-5-(4-Nitrophenyl)-2,4-pentadienal; or
iv) any combination of i), ii) and iii).

In accordance with embodiment 9 the method of any one of embodiments 5-8 is provided wherein the algae species is contacted with said polyunsaturated aldehyde, or combination thereof, as a first agent in conjunction with contacting the algae species with a second active agent, wherein the second active agent is a commercial algicide.

In accordance with embodiment 10, the method of any one of embodiments 2-4 or 9 is provided wherein the first and second active agents are applied sequentially, optionally within about 1 to 8 hours of each other.

In accordance with embodiment 11, the method of any one of embodiments 2-4 or 9 is provided wherein the first and second active agents are applied simultaneously.

In accordance with embodiment 12, the method of embodiment 11 is provided wherein the first and second active agents are applied as a mixture in a single composition.

In accordance with embodiment 13, the method of embodiment 12 is provided wherein the first and second active agents are each formulated in solid particulate form and said single composition comprises a mixture of the first active agent particulates and the second active agent particulates.

In accordance with embodiment 14, the method of embodiment 12 is provided wherein the first and second active agents are each formulated as liquids and the single composition comprises a mixture of the two liquids.

In accordance with embodiment 15, the method of any one of embodiments 1-4 or 9-14 is provided wherein the first active agent is a polyunsaturated aldehyde infochemical.

In accordance with embodiment 16, the method of any one of embodiments 9-15 is provided wherein the first active agent is a polyunsaturated aldehyde or sterol sulfate, and the second active agent is a commercial algicide, optionally wherein the commercial algicide is applied at 100%, or less than 100%, 50%, 25%, 15%, 10% or 5% of the recommended dosage.

In accordance with embodiment 17, the method of embodiment 16 is provided wherein the commercial algicide is selected from AlgaeFix™, DINO X, Aquathol® K, GreenClean® PRO and Cutrine® Plus

In accordance with embodiment 18, the method of embodiment 16 is provided wherein the commercial algicide is selected from AlgaeFix™, DINO X, and Aquathol® K.

In accordance with embodiment 19, the method of embodiment 16 is provided wherein the commercial algicide is AlgaeFix™.

In accordance with embodiment 20, the method of embodiment 16 is provided wherein the commercial algicide is DINO X.

In accordance with embodiment 21, the method of embodiment 16 is provided wherein the commercial algicide is Aquathol® K.

In accordance with embodiment 22, the method of any one of embodiments 16-21 wherein the first active agent comprises:
i) cholesterol-3-sulfate;
ii) trans,trans-2,4-decadienal;
iii) (E,E)-5-Phenyl-2,4-pentadienal;
iv) (2E,4E)-5-(4-Nitrophenyl)-2,4-pentadienal; or
v) any combination of i), ii) iii) and iv).

In accordance with embodiment 23, the method of any one of embodiments 1-22 is provided wherein the active agents are formulated as liquids and the body of water is contacted with the active agents by spraying the liquids uniformly over the water surface.

In accordance with embodiment 24, the method of any one of embodiments 1-22 is provided wherein the active agents are formulated as solid granules that release the active components over time.

In accordance with embodiment 25, the method of any one of embodiments 1-22 is provided wherein the algae species is Didymosphenia geminata.

In accordance with embodiment 26 a method for improving the efficacy of a commercial algicide to inhibit the growth of a unicellular algae species in a body of water is provided wherein the method comprises contacting the algae species with an isolated polyunsaturated aldehyde infochemical in conjunction with contacting the algae species with a commercial algicide selected from the group consisting of 0.1× AlgaeFix™, 0.1×DINO X, 0.1× Aquathol® K, 0.1× GreenClean® PRO and 0.1× Cutrine® Plus.

In accordance with embodiment 27, the method of embodiment 26 is provided wherein the polyunsaturated aldehyde infochemical is trans,trans-2,4-decadienal or decatrienal.

In accordance with embodiment 28, the method of embodiment 26 is provided wherein the polyunsaturated aldehyde is (E,E)-5-Phenyl-2,4-pentadienal or (2E,4E)-5-(4-Nitrophenyl)-2,4-pentadienal.

In accordance with embodiment 29, the method of embodiment 27 or 28 is provided wherein the commercial algicide is selected from AlgaeFix™, DINO X, Aquathol® K, GreenClean® PRO and Cutrine® Plus.

In accordance with embodiment 30, the method of embodiment 27 or 28 is provided wherein the commercial algicide is selected from AlgaeFix™, DINO X, and Aquathol® K.

In accordance with embodiment 31, the method of embodiment 27 or 28 is provided wherein the commercial algicide is AlgaeFix™.

In accordance with embodiment 32, the method of embodiment 27 or 28 is provided wherein the commercial algicide is DINO X.

In accordance with embodiment 33, the method of embodiment 27 or 28 is provided wherein the commercial algicide is Aquathol® K.

In accordance with embodiment 34, the method of any one of embodiments 26-33 is provided wherein the active agents are formulated as liquids and body of water is contacted with the active agents by spraying the liquids uniformly over the water surface.

In accordance with embodiment 35, the method of any one of embodiments 26-33 is provided wherein the active agents are formulated as solid granules that release the active components over time.

In accordance with embodiment 36, the method of any one of embodiments 1-33 is provided wherein the algae species is Didymosphenia geminata.

In accordance with embodiment 37 a composition for inhibiting the growth of a unicellular algae species is provided wherein the composition comprises an isolated polyunsaturated aldehyde; and a commercial algicide selected from the group consisting of AlgaeFix™, DINO X, Aquathol® K, GreenClean® PRO and Cutrine® Plus.

In accordance with embodiment 38 a composition of embodiment 37 is provided wherein the polyunsaturated aldehyde is selected from the group consisting of
i) trans,trans-2,4-decadienal;
ii) (E,E)-5-Phenyl-2,4-pentadienal;
iii) (2E,4E)-5-(4-Nitrophenyl)-2,4-pentadienal; or
iv) any combination of i), ii) and iii).

In accordance with embodiment 39 a composition of embodiment 37 or 38 is provided wherein the composition is in the form of a liquid.

In accordance with embodiment 40 a composition of embodiment 37 or 38 is provided wherein the composition is in the form of solid granules that release the active components over time upon contact with an aqueous medium.

In accordance with embodiment 41 a composition of embodiment 37 or 38 is provided wherein the composition comprises a mixture of a first set of granules comprising said polyunsaturated aldehyde, and a second set of granules comprising said commercial algicide.

In accordance with embodiment 42 a composition of any one of embodiments 35-41 is provided wherein the polyunsaturated aldehyde is trans,trans-2,4-decadienal or decatrienal.

In accordance with embodiment 43 a composition of any one of embodiments 1-44 is provided wherein the polyunsaturated aldehyde is trans,trans-2,4-decadienal.

### Example 1

### Materials and Methods

### Algal Culturing

Seed culture of the freshwater diatom Encyonema minutum var. pseudogracialis (referred to hereafter as “Em”) was purchased and obtained from the University of Texas Culture Collection of Algae (UTEX). Culture was grown at UTEX facilities in CR1-S algal medium until it reached acceptable biomass, and was mailed overnight to Battelle Memorial Institute (BMI) in Columbus, OH. Upon receipt, the culture was immediately brought into the lab, unpacked, their lids cracked open, and placed on a rack on a table with a grow light. Cultures were checked regularly for growth, and upon reaching suitable biomass, were subdivided into several 50 mL vented conical tubes and continuously maintained. Em was maintained and tested at BMI in a modified filter-sterilized CR1-S algal medium with no soil particles so as to improve visualization and counting speed and accuracy.

### Experimental Procedure

All experiments were conducted in untreated polystyrene 96-well plates. Total liquid volume added to each well was 200 μL for all assays. At the start of each experiment, a conical tube of diatom Em was split into two and given fresh media (1:1 algae:media), then examined under a microscope to confirm vitality.

Lethality experiments were conducted with 6 different commercial algicides (AlgaeFix™, DINO X, Aquathol® K, Cutrine® Plus, GreenClean® PRO, and Hydrothol® 191 Granular) and two infochemicals (trans,trans-2,4-decadienal [TDD] and cholesterol-3-sulfate [C3S]). Fresh 50 mM or 25 mM stock solutions of each infochemical were prepared in DMSO immediately prior to each experiment. These initial stocks were diluted as needed in DMSO to obtain varying concentrations; 4 μL of the appropriate solution was added to a well (final volume 200 μL) to achieve desired test concentration. For algicide testing, initial solutions were prepared in distilled (DI) water that were 10× the manufacturer's recommended dose (x) according to product labelling; in cases where there was a range of recommended doses, the highest dosing was selected. For each algicide treatment, 20 μL of a 1× solution was added to a well (final volume 200 μL). For combination testing, each well had 176 μL of algae, plus 20 μL of algicide or solvent (DI), plus 4 μL of test compound or solvent (DMSO). Plates were set up in a single-blind protocol, where one staff member added treatments to the 96-well plate in triplicate in a random pattern. Three wells contained algae only (Negative Control) and were always placed in wells A1, A2, and A3. The plates were incubated under room lighting at 20° C. for ˜24 hours.

Following incubation, 1.5 μL of filtered Neutral Red (0.8 g in 25 mL DI) for every 100 μL of solution (3 μL for 200 μL) was added to each well. Neutral Red (NR) is a vital stain that is visible to the naked eye. Live cells uptake Neutral Red into their lysosomes and develop a strong red color as a result; dead cells remain unstained. After addition of NR, plates were left on the benchtop for 2 hours before counting. A different staff member counted cells in 5 μL from each well using a hemocytometer under a microscope; this second staff member was not told which treatments were in which wells, so as to maintain single-blind data collection. Total cells were counted, along with live/dead characterization via Neutral Red vital cell staining, and time of well count completion.

### Results

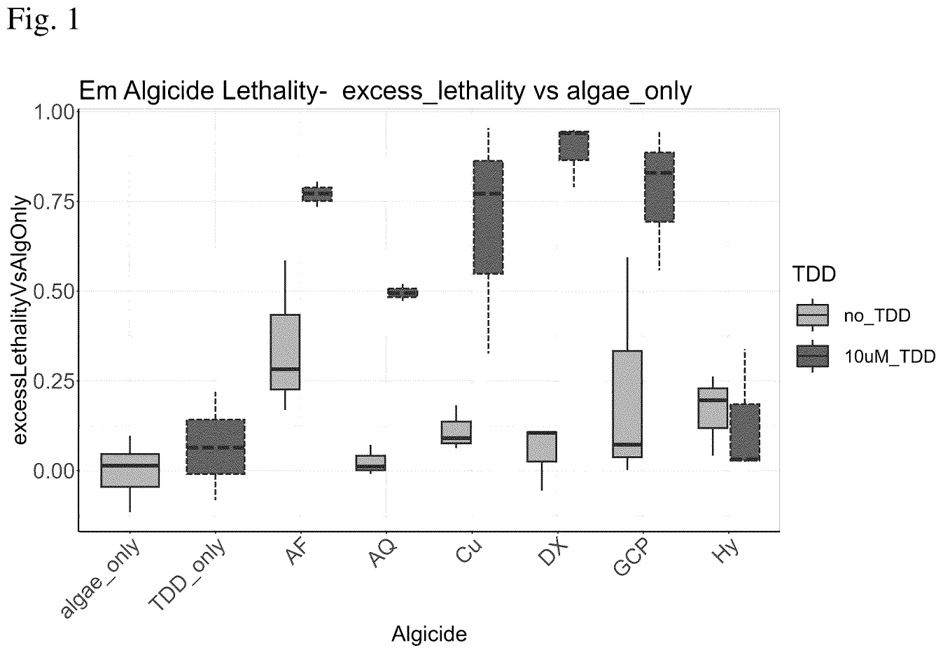

Assay results revealed that none of the commercial algicides tested at 10% of MRD had a strong effect on Em (mortality less than ^{˜}40%). Further, low concentrations of the infochemicals tested had little effect on Em. However, when tested together, strong effects were observed for TDD and 5 of the 6 tested algicides. Low concentration of TDD (10 μM) combined with a low concentration of commercial algicide (10% MRD) led to diatom mortality exceeding simple combination toxicity (FIG. 1 and Table 1).

Table 1. Statistical demonstration of synergistic interactions between TDD and algicides leading to increased mortality. “Single treatment”: lethality above negative control due to addition of indicated chemical; “Arithmetic sum lethality”: result of arithmetically summing the lethality of the indicated algicide with that of TDD; “Observed combination lethality”: experimentally-observed lethality when Em was exposed to both TDD and indicated algicide simultaneously; “t-test p-value”: result of a Student's t-test between the arithmetic sum lethality and observed combination lethality, where a value less than 0.05 indicates that the observed combination lethality is significantly higher than the simple arithmetic sum, thus indicating synergism. For all treatments, n=3.

TABLE 1

| | | | Observed | | | |
|---|---|---|---|---|---|---|
| | Single | Arithmetic | combination | | t-test | Significant |
| Treatment | treatment | sum lethality | lethality | Difference | p-value | (p < 0.05) |
| 0.1X AlgaeFix ™ | 34.6% | 41.3% | 76.9% | 35.6% | 0.009 | * |
| 0.1X Hydrothol ® 191 | 16.7% | 23.4% | 13.1% | −10.2% | 0.194 | |
| 0.1X DINO X | 5.2% | 11.9% | 89.2% | 77.3% | 0.006 | * |
| 0.1X Aquathol ® K | 2.5% | 9.2% | 49.5% | 40.4% | 0.020 | * |
| 0.1X GreenClean ® PRO | 22.3% | 29.0% | 77.6% | 48.7% | 0.121 | |
| 0.1X Cutrine ® Plus | 11.2% | 17.9% | 68.4% | 50.5% | 0.080 | |
| 10 μM TDD | 6.7% | | | | | |

Synergistic lethality was demonstrated by the data. For example, 0.1×DINO X algaecide led to 5.2% death, 10 μM TDD led to 6.7% death; non-synergistic (additive) toxicity model, expected when two toxins have to same mechanism of action, would predict approximately 11.9% mortality when Em was exposed to both chemicals simultaneously. However, the experimental combination of the two chemicals led to 89.2% death, significantly higher than the simple sum (p<0.01), indicating a synergistic interaction. T-tests supported synergistic interactions of TDD with AlgaeFix™, DINO X and Aquathol® K; TDD combined with Cutrine® Plus or GreenClean® PRO led to higher lethality (by 50.5% and 48.7% respectively) but without statistical significance. No effect was seen for TDD combined with Hydrothol® 191 Granular.

### Example 2

### Synthesis of Bisconjugated Aldehydes

The preparation of bisconjugated aldehydes 3 proceeded through a Wittig reaction between conjugated aldehdye 1 and 2-(triphenylphosphoranylidene) acetaldehyde 2.

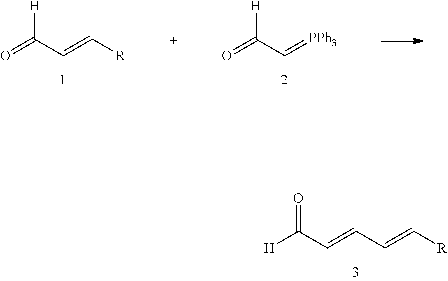

### Example 1

### 5-phenyl-2,4-pentadienal

Cinnamaldehdye (52 mg, 0.39 mmol) and 2-(triphenylphosphoranylidene) acetaldehyde (125 mg, 0.413 mmol) were dissolved in toluene (20 mL) and then heated to 80° C. The solution was heated with stirring for 14 days until the reaction was shown to be complete by GC-MS. The solvent was removed under vacuum and the resulting residue product was confirmed by H¹ NMR analysis. The material was used as-is without further purification.

By using the process described in the above Example 1 and the corresponding starting materials, the following compounds were obtained in analogous manner:
5-(4-nitrophenyl)-2,4-pentadienal
5-(3-furanyl)-2,4-pentadienal
5-(4-bromophenyl)-2,4-pentadienal
5-[4-(acetoloxy)-3-methoxyphenyl]2,4-pentadienal
5-(9-anthracenyl)-2,4-penta-2,4-dienal
ethyl-6-oxo-2,4-hexadienoate

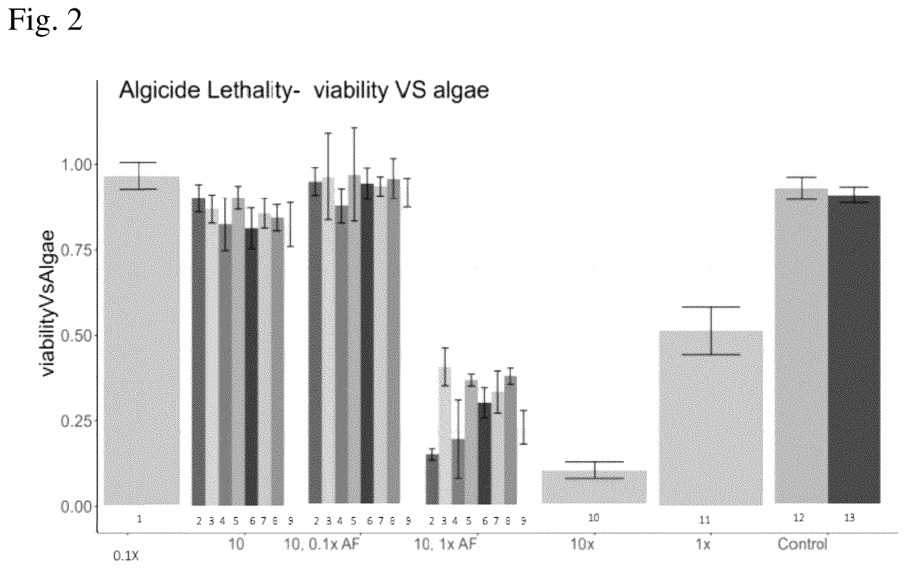

The effects of dienal infochemicals (TDD, and novel chemicals based on TDD) on the freshwater diatom alga Gomphonema affine, with and without the addition of the commercial algicide AlgaeFix was investigated. The results of those experiments are shown in the bar graph of FIG. 2.

Referencing FIG. 2, the designation 0.1× refers to a dose of AlgaeFix at 0.1× the manufacturer's recommended dose (MRD). The designation 10 represents a 10 μM dose of the dienal compound, with numbered lanes 2-9 corresponding to the different dienals tested. The designation 10, 0.1×AF represents diatoms that received a dose of 10 μM of dienal, as well as a 0.1×MRD of AlgaeFix. The 10, 1×AF designation represents a dosage of 10 μM dienal, and 1× the MRD of AlgaeFix. The designation of 10× in lane 10 represents algae contacted with a dose of AlgaeFix at 10× the MRD. The designation of 1× in lane 11 represents algae contacted with a dose of AlgaeFix at 1× the MRD. Control lanes 12 and 13 represents a dose of 4 μL DMSO—the carrier for the dienals—and 20 μL water—the carrier for the commercial algicide, respectively.

This data shows that dosing with AlgaeFix at the MRD only kills about 50% of the diatoms. By adding in 10 μM of certain dienals, the mortality increases to around 85%—similar to a 10× dose of algicide alone. This demonstrates that by adding in certain dienals, the effectiveness of an algicide against diatoms can be increased.

1. A method for inhibiting the growth of a unicellular algae species in a body of water, said method comprising contacting the algae species with a composition comprising an effective amount of an exogenous source of a first active agent that induces programmed-cell-death.

2. The method of claim 1 wherein said method comprises contacting the algae species with said first active agent and a second active agent, wherein the second active agent is distinct from the first active agent.

3. The method of claim 2 wherein the first and second active agents are independently selected from:
i) a sterol sulfate having the general structure of: 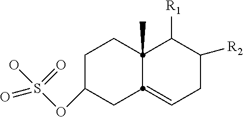
wherein R₁ and R₂ together with the atoms to which they are bound form a sterol, optionally wherein the sterol sulfate is cholesterol-3-sulfate (C3S);
ii) a dienal having the general structure of 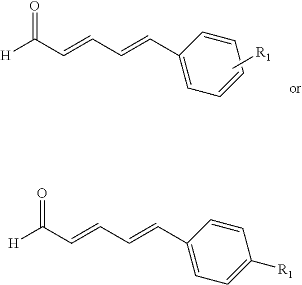
wherein R₁ is selected from the group consisting of H, halo, NH₂, NO₂ and OCH₃; or
iii) a compound selected from the group consisting of
trans,trans-2,4-decadienal,
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate and
3-[3-(4-Fluorophenyl)-2,3-dihydro-1-(1-methylethyl)-1H-indol-2-yl]-2,4-pentadienal.

4. The method of claim 3 wherein the first and second active agents are applied simultaneously.

5. The method of claim 2 wherein the first active agent is independently selected from:
i) a sterol sulfate having the general structure of: 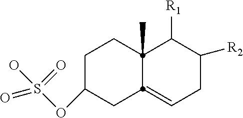
wherein R₁ and R₂ together with the atoms to which they are bound form a sterol, optionally wherein the sterol sulfate is cholesterol-3-sulfate (C3S);
ii) a dienal having the general structure of 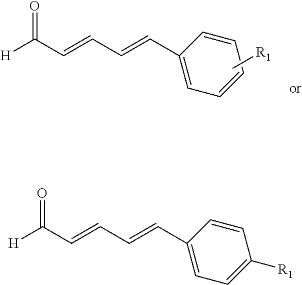
wherein R₁ is selected from the group consisting of H, halo, NH₂, NO₂ and OCH₃; or
iii) a compound selected from the group consisting of
trans,trans-2,4-decadienal,
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate and
3-[3-(4-Fluorophenyl)-2,3-dihydro-1-(1-methylethyl)-1H-indol-2-yl]-2,4-pentadienal; and
the second active agent is a commercial algicide, wherein the commercial algicide is applied at, or less than, the manufacturer's recommended dosage.

6. The method of claim 5 wherein the first active agent and the commercial algicide are applied simultaneously.

7. The method of claim 5 wherein the first active agent is a polyunsaturated aldehyde selected from
i) trans,trans-2,4-decadienal;
ii) (E,E)-5-Phenyl-2,4-pentadienal;
iii) (2E,4E)-5-(4-Nitrophenyl)-2,4-pentadienal; or
iv) any combination of i), ii) and iii).

8. The method of claim 1 wherein the composition is in the form of a liquid and the algae species is contacted with said composition by spraying the composition uniformly over the water surface.

9. The method of claim 1 wherein the composition is in the form of solid granules that release the active components over time.

10. The method of claim 1 wherein the algae species is Didymosphenia geminata.

11. A method for enhancing the efficacy of a commercial algicide to inhibit the growth of a unicellular algae species in a body of water, said method comprising contacting the algae species with
an isolated polyunsaturated aldehyde; and
a commercial algicide comprising a compound selected from the group consisting of copper sulfate, Poly(oxyethylene) (dimethylimino) ethylene (dimethylimino) ethylene dichloride, sodium percarbonate, endothall, sodium carbonate peroxyhydrate and copper ethanolamine as the active agent.

12. The method of claim 11 wherein the commercial algicide is selected from the group consisting of AlgaeFix™, DINO X, Aquathol® K, GreenClean® PRO and Cutrine® Plus.

13. The method of claim 11 wherein the polyunsaturated aldehyde is
i) a dienal having the general structure of 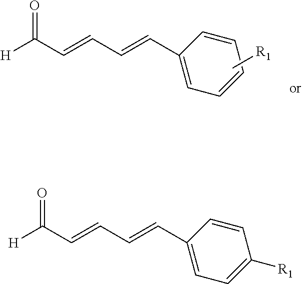
wherein R₁ is selected from the group consisting of H, halo, NO₂ and OCH₃; or
ii) a compound selected from the group consisting of
trans,trans-2,4-decadienal,
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate and
3-[3-(4-Fluorophenyl)-2,3-dihydro-1-(1-methylethyl)-1H-indol-2-yl]-2,4-pentadienal.

14. The method of claim 13 wherein the polyunsaturated aldehyde and the commercial algicide are formulated as liquids and the algae species is contacted by spraying the liquids uniformly over the water surface.

15. The method of claim 13 wherein the polyunsaturated aldehyde and the commercial algicide are formulated as solid granules that release the active components upon contact with an aqueous medium.

16. The method of claim 13 wherein the polyunsaturated aldehyde and the commercial algicide are mixed together and said mixture is placed in contact with said algal species.

17. The method of claim 16 wherein the algae species is Didymosphenia geminata.

18. A composition for inhibiting the growth of a unicellular algae species, said composition comprising
an isolated polyunsaturated aldehyde selected from:
i) a dienal having the general structure of 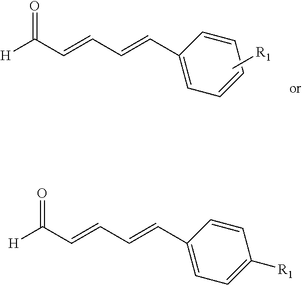
wherein R₁ is selected from the group consisting of H, halo, NH₂, NO₂ and OCH₃; or
ii) a compound selected from the group consisting of
trans,trans-2,4-decadienal,
(E,E)-5-Phenyl-2,4-pentadienal,
(2E,4E)-5-(4-Nitrophenyl)-2,4-pentadienal,
(2E,4E)-5-[4-(Dimethylamino)phenyl]-2,4-pentadienal,
(2E,4E)-5-(3-Furanyl)-2,4-pentadienal,
(2E,4E)-5-(4-Bromophenyl)-2,4-pentadienal,
5-(4-Methoxyphenyl)penta-2,4-dienal,
5-[4-(Acetyloxy)-3-methoxyphenyl]-2,4-pentadienal,
(E,E)-5-(9-anthracenyl)-2,4-penta-2,4-dienal,
(E,E)-2,4-Heptadienal,
Methyl (2E,4E)-6-oxo-2,4-hexadienoate and
3-[3-(4-Fluorophenyl)-2,3-dihydro-1-(1-methylethyl)-1H-indol-2-yl]-2,4-pentadienal; and
a commercial algicide, optionally selected from the group consisting of AlgaeFix™, DINO X, Aquathol® K, GreenClean® PRO and Cutrine® Plus.

19. The composition of claim 18 wherein the composition is in the form of a liquid.

20. The method of claim 18 wherein the composition is in the form of solid granules that release the active components over time upon contact with an aqueous medium.
